(19) United States
(12) Patent Application Publication
(10) Pub. No.: US 2023/0398839 A1
(43) Pub. Date: Dec. 14, 2023

(54) RAILROAD VEHICLE AIR CONDITIONING APPARATUS

(71) Applicant: Mitsubishi Electric Corporation, Tokyo (JP)

(72) Inventor: Katsuhiro FUJIKI, Tokyo (JP)

(73) Assignee: Mitsubishi Electric Corporation, Tokyo (JP)

(21) Appl. No.: 18/124,207

(22) Filed: Mar. 21, 2023

(30) Foreign Application Priority Data
Jun. 8, 2022 (JP) 2022-093311

(51) Int. Cl. B60H 1/32

(52) U.S. Cl. CPC B60H 1/3233

(57) ABSTRACT

In a railroad vehicle air conditioning apparatus, an indoor heat exchanger is arranged within a housing at a position through which a flow of air passes. A drain pan is arranged within the housing below the indoor heat exchanger. A gap is left between a lower end portion of the indoor heat exchanger and a bottom surface of the drain pan. A blocking member is detachable from the indoor heat exchanger and includes a resilient close-contact portion that is in resiliently close contact with the bottom surface of the drain pan and a blocking portion that blocks between the resilient close-contact portion and the indoor heat exchanger so as to transmit to the resilient close-contact portion at least a part of load of the indoor heat exchanger.

### CROSS-REFERENCE TO RELATED APPLICATIONS

This application claims the benefit of Japanese Patent Application No. 2022-93311, filed on Jun. 8, 2022, the entire disclosure of which is incorporated by reference herein.

### FIELD OF THE INVENTION

This application relates to a railroad vehicle air conditioning apparatus.

### BACKGROUND OF THE INVENTION

A railroad vehicle air conditioning apparatus that performs air conditioning of a vehicular compartment of a railroad vehicle includes a housing mounted on the railroad vehicle and an air conditioner housed in the housing. The air conditioner includes an indoor heat exchanger that performs heat exchange with air of the vehicular compartment and an indoor fan that that facilitates the heat exchange.

The housing has a return port and an outlet port that each open to the vehicular compartment of the railroad vehicle. The indoor fan forms, within the housing, a flow of air directed toward the outlet port from the return port. The indoor heat exchanger is arranged at a position through which the flow of air passes. Further, a drain pan for receiving condensation water condensed at the indoor heat exchanger is arranged below the indoor heat exchanger.

As disclosed in Patent Literature 1 (Unexamined Japanese Patent Application Publication No. 2015-67258), a railroad vehicle air conditioning apparatus is known that has configuration in which a gap is left between a lower end portion of an indoor heat exchanger and a bottom surface of a drain pan.

If a flow of air formed by an indoor fan passes through the gap, an amount of air passing through the indoor heat exchanger is reduced by an amount of air passing through the gap. This reduction degrades efficiency of heat exchange by the indoor heat exchanger. Additionally, condensation water accumulated at the lower end portion of the indoor heat exchanger may possibly be scattered toward an outlet port along with the flow of air. The condensation water scattered toward the outlet port may possibly intrude into a duct and thus may possibly cause production of bad odor.

Thus, plugging the gap between the lower end portion of the indoor heat exchanger and the bottom surface of the drain pan by packing is conceivable. However, such packing impairs ease of maintenance of the railroad vehicle air conditioning apparatus.

### SUMMARY OF THE INVENTION

An objective of the present disclosure is to provide a railroad vehicle air conditioning apparatus that is easy to maintain, despite low reduction in an amount of air passing through an indoor heat exchanger and despite suppression of scattering of condensation water toward an outlet port.

To achieve the above objective, a railroad vehicle air conditioning apparatus according to the present disclosure includes a housing, an indoor fan, an indoor heat exchanger, and a drain pan. The housing is disposed in a railroad vehicle and has a return port and an outlet port that each open to a vehicular compartment of the railroad vehicle. The indoor fan is housed in the housing and forms, within the housing, a flow of air directed toward the outlet port from the return port. The indoor heat exchanger is arranged within the housing at a position through which the flow of the air passes and performs heat exchange between the air and a refrigerant. The drain pan is arranged within the housing below the indoor heat exchanger and receives condensation water condensed at the indoor heat exchanger. A lower end portion of the indoor heat exchanger is positioned, separately from a bottom surface of the drain pan, above the bottom surface. The railroad vehicle air conditioning apparatus further includes a blocking member that is detachable from the indoor heat exchanger and includes a resilient close-contact portion that is in resiliently close contact with the bottom surface of the drain pan, and a blocking portion that blocks between the resilient close-contact portion and the indoor heat exchanger in a manner so as to transmit to the resilient close-contact portion at least a part of load of the indoor heat exchanger.

### BRIEF DESCRIPTION OF THE DRAWINGS

A more complete understanding of this application can be obtained when the following detailed description is considered in conjunction with the following drawings, in which:

FIG. 1 is a plan view of a railroad vehicle air conditioning apparatus according to Embodiment 1;

FIG. 2 is a schematic drawing illustrating configuration of a main part of the railroad vehicle air conditioning apparatus according to Embodiment 1;

FIG. 3 is a schematic drawing illustrating configuration of a main part of a railroad vehicle air conditioning apparatus according to Embodiment 2;

FIG. 4 is a schematic drawing illustrating configuration of a main part of a railroad vehicle air conditioning apparatus according to Embodiment 3; and

FIG. 5 is a schematic drawing illustrating configuration of a main part of a railroad vehicle air conditioning apparatus according to Embodiment 4.

### DETAILED DESCRIPTION OF THE INVENTION

Hereinafter, railroad vehicle air conditioning apparatuses according to embodiments are described with reference to the drawings. In the drawings, components that are the same or equivalent are assigned the same reference sign.

### Embodiment 1

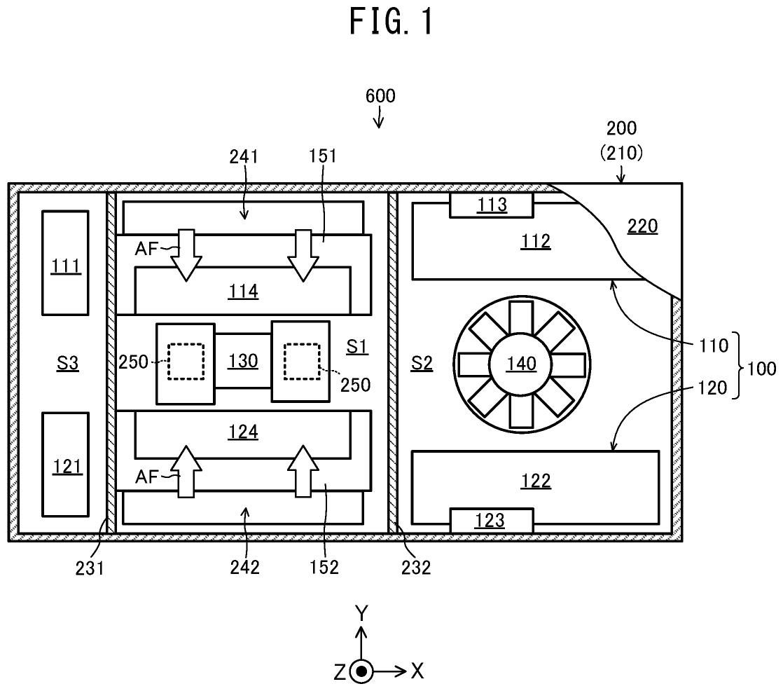

As illustrated in FIG. 1, a railroad vehicle air conditioning apparatus 600 according to the present embodiment includes a housing 200 that is mounted on a railroad vehicle and an air conditioner 100 that is housed in the housing 200 and performs air conditioning of a passenger compartment as a vehicular compartment of the railroad vehicle. The housing 200 and the air conditioner 100 are arranged at a roof portion of the railroad vehicle.

The air conditioner 100 includes refrigeration cycle devices 110 and 120 using two refrigeration systems, each providing a refrigeration cycle using a refrigerant.

One refrigeration cycle device of the refrigeration cycle devices, that is, the refrigeration cycle device 110, includes a compressor 111 that compresses the refrigerant, an outdoor heat exchanger 112 that functions as a condenser for condensing the compressed refrigerant, an expander 113 that expands the condensed refrigerant, and an indoor heat exchanger 114 that functions as an evaporator for evaporation of the expanded refrigerant. The indoor heat exchanger 114 performs heat exchange between air sucked in from the passenger compartment and the refrigerant. The compressor 111, the outdoor heat exchanger 112 and the expander 113 are included in a cooperating devices group for providing a refrigeration cycle together with the indoor heat exchanger 114.

Similarly, the other refrigeration cycle device of the refrigeration cycle devices, that is, the refrigeration cycle device 120, includes a compressor 121, an outdoor heat exchanger 122 that functions as a condenser, an expander 123, and an indoor heat exchanger 124 that functions as an evaporator. The indoor heat exchanger 124 performs heat exchange between air sucked in from the passenger compartment and the refrigerant. The compressor 121, the outdoor heat exchanger 122 and the expander 123 are included in a cooperating devices group for providing a refrigeration cycle together with the indoor heat exchanger 124.

Furthermore, the air conditioner 100 includes an indoor fan 130 that facilitates the heat exchange between the air of the passenger compartment and the indoor heat exchangers 114 and 124 and an outdoor fan 140 that facilitates heat exchange between air outside the railroad vehicle and the outdoor heat exchangers 112 and 122.

To facilitate explanation below, a right-handed XYZ orthogonal coordinate system is defined with X-axis that is parallel to a length direction of the railroad vehicle, Y-axis that is parallel to a width direction of the railroad vehicle, and Z-axis that is parallel to a vertical direction. A vertically upward direction is the positive Z-axis direction.

The housing 200 has, in a plan view in a direction parallel to the Z-axis, a shape of a rectangle that has long sides parallel to the X-axis and short sides parallel to the Y-axis. The housing 200 includes a boxy base frame 210 that has a bottom plate and a top board 220 that closes a top opening of the base frame 210 to define, together with the base frame 210, a housing space for housing the air conditioner 100. In order to illustrate the inside of the housing 200, FIG. 1 illustrates only a part of the top board 220.

Furthermore, the housing 200 includes partition plates 231 and 232 that partition the housing space defined by the base frame 210 and the top board 220 into an indoor chamber S1, an outdoor chamber S2 and a compressor chamber S3 aligned in an X-axis direction.

The indoor chamber S1 houses the indoor heat exchangers 114 and 124 and the indoor fan 130. The outdoor chamber S2 houses the outdoor heat exchangers 112 and 122, the expanders 113 and 123, and the outdoor fan 140. The compressor chamber S3 houses the compressors 111 and 121.

The housing 200 has, in a bottom surface thereof at the indoor chamber S1, return ports 241 and 242 and outlet ports 250 that each open to the passenger compartment of the railroad vehicle.

The outlet ports 250 are arranged at a central part of the indoor chamber S1 in a Y-axis direction. One return port of the return ports, that is, the return port 241, is arranged at one end portion of the indoor chamber S1 in the Y-axis direction. The other return port of the return ports, that is, the return port 242, is arranged at the other end portion of the indoor chamber S1 in the Y-axis direction.

The indoor fan 130 described above is arranged at a position of the outlet ports 250. Specifically, the indoor fan 130 is allocated to the outlet ports 250. One indoor heat exchanger of the indoor heat exchangers, that is, the indoor heat exchanger 114, is arranged between the one return port 241 and the outlet ports 250. The other indoor heat exchanger of the indoor heat exchangers, that is, the indoor heat exchanger 124, is arranged between the other return port 242 and the outlet ports 250.

The indoor fan 130 forms, in the indoor chamber S1, airflows AF directed toward the outlet ports 250 from the return ports 241 and 242.

Specifically, the indoor fan 130 sucks up the air of the passenger compartment to the indoor chamber S1 through the return ports 241 and 242. The air sucked up through the one return port 241 passes through the one indoor heat exchanger 114, and the air sucked up through the other return port 242 passes through the other indoor heat exchanger 124. Further, the indoor fan 130 causes the air passed through the indoor heat exchangers 114 and 124 to return to the passenger compartment through the outlet ports 250.

When the indoor heat exchangers 114 and 124 that function as evaporators perform heat exchange with the air of the passenger compartment, water in the air condenses on surfaces of the indoor heat exchangers 114 and 124. Condensation water that is water condensed on the surfaces of the indoor heat exchangers 114 and 124 drips from the indoor heat exchangers 114 and 124.

Thus, the air conditioner 100 includes a drain pan 151 arranged below the one indoor heat exchanger 114 in the indoor chamber S1 and a drain pan 152 arranged below the other indoor heat exchanger 124 in the indoor chamber S1. The drain pan 151 receives the condensation water dripped from the indoor heat exchanger 114. The drain pan 152 receives the condensation water dripped from the indoor heat exchanger 124.

The structure around the indoor heat exchanger 114 and the drain pan 151 and the structure around the indoor heat exchanger 124 and the drain pan 152 are the same. Thus, as a representative structure, the structure around the indoor heat exchanger 124 and the drain pan 152 is described below in detail.

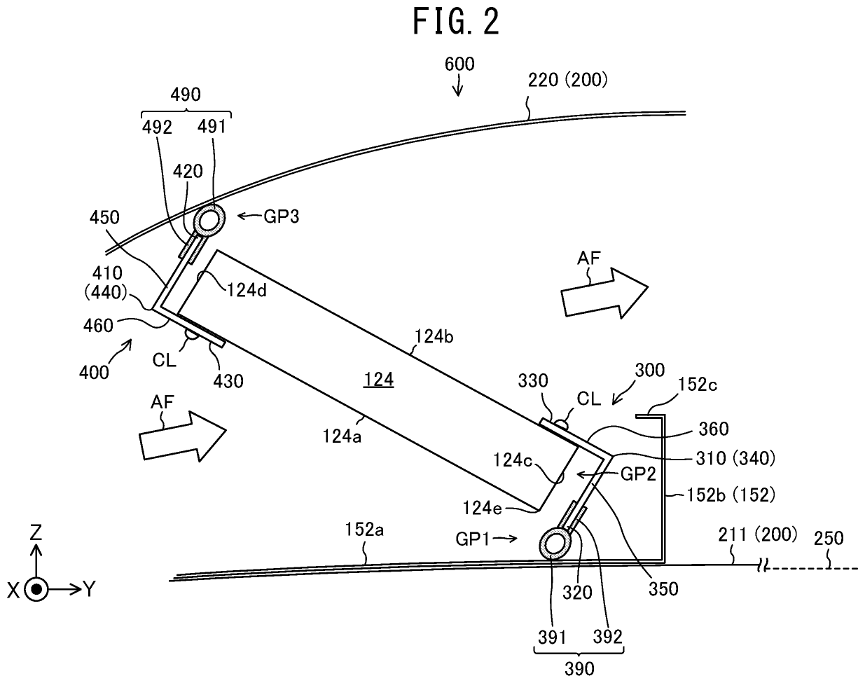

As illustrated in FIG. 2, the drain pan 152 is on a bottom surface 211 of the housing 200. The drain pan 152 has a bottom surface 152a onto which the condensation water condensed at the indoor heat exchanger 124 drips, and includes a water shutoff wall 152b extending upward from the bottom surface 152a in a Z-axis direction. FIG. 2 illustrates configuration in which the water shutoff wall 152b is arranged between the indoor heat exchanger 124 and the indoor fan 130 illustrated in FIG. 1.

The water shutoff wall 152b has, at an upper end thereof, a water return portion 152c bent in a direction toward the indoor heat exchanger 124, more specifically, a negative Y-axis direction.

The indoor heat exchanger 124 has a lower surface 124a facing the bottom surface 152a of the drain pan 152 and an upper surface 124b that is opposite to the lower surface 124a with respect to a thickness direction of the indoor heat exchanger 124. Further, the indoor heat exchanger 124 has end surfaces connecting the upper surface 124b and the lower surface 124a. FIG. 2 illustrates, among the end surfaces of the indoor heat exchanger 124, a lower end surface 124c and an upper end surface 124d. The upper end surface 124d is at a position opposite to the lower end surface 124c with respect to a length direction of the indoor heat exchanger 124 that is perpendicular to the X-axis direction.

The indoor heat exchanger 124 is arranged with inclination such that the lower surface 124a approaches the bottom surface 152a of the drain pan with approach to the outlet ports 250. The lower end surface 124c is positioned below the upper end surface 124d.

A lower end portion 124e of the indoor heat exchanger 124 is positioned, separately from the bottom surface 152a of the drain pan 152, above the bottom surface 152a. Specifically, a first gap GP1 is left between the lower end portion 124e of the indoor heat exchanger 124 and the bottom surface 152a of the drain pan 152.

Part of the reason for this is to prevent the lower end portion 124e from damaging the bottom surface 152a of the drain pan 152 by shaking along the Z-axis direction due to travelling of the railroad vehicle. The lower end portion 124e of the indoor heat exchanger 124 in the present embodiment is, more specifically, a corner portion of the indoor heat exchanger 124 that is positioned at a boundary between the lower surface 124a and the lower end surface 124c.

On the other hand, if the airflow AF passes through the first gap GP1, an amount of air passing through the indoor heat exchanger 124 is reduced by an amount of air passing through the first gap GP1. This reduction degrades efficiency of the heat exchange by the indoor heat exchanger 124.

Additionally, the condensation water accumulated at the lower end portion 124e of the indoor heat exchanger 124 may possibly be scattered toward the outlet ports 250 along with the airflow AF. The condensation water scattering toward the outlet ports 250 may possibly intrude into a duct and thus may possibly cause production of bad odor. Note that the broken line in FIG. 2 indicates the outlet ports 250 and the indoor fan 130 is not illustrated in FIG. 2.

In particular, as indicated in FIG. 2 by the broken line, in the housing 200 according to the present embodiment, the outlet ports 250 are formed at a position of equal height to a position of the bottom surface 152a of the drain pan 152 or at a position of lower height than the position of the bottom surface 152a of the drain pan 152. Due to this, intrusion of the condensation water into the outlet ports 250 is likely to occur upon occurrence of scattering of the condensation water.

Thus, plugging the first gap GP1 by packing is conceivable. However, such packing degrades ease of maintenance of the indoor heat exchanger 124, the drain pan 152, and the like. In view of the aforementioned circumstances, the railroad vehicle air conditioning apparatus 600 according to the present embodiment includes a blocking member 300, so as to be easy to maintain, despite low reduction in the amount of air passing through the indoor heat exchanger 124 and despite suppression of scattering of the condensation water toward the outlet ports 250.

The blocking member 300 includes a resilient close-contact portion 390 that is in resiliently close contact with the bottom surface 152a of the drain pan 152 and a blocking portion 310 that blocks between the resilient close-contact portion 390 and the indoor heat exchanger 124 in a manner so as to transmit to the resilient close-contact portion 390 a part of load of the indoor heat exchanger 124. The blocking portion 310 suppresses passage of the airflow AF through the first gap GP1.

The resilient close-contact portion 390 is formed of a synthetic resin, more specifically, an elastomer. A thermoplastic elastomer is preferable as the elastomer. The resilient close-contact portion 390 is less likely to absorb water as compared to sponge, a thermal insulator, or the like, and thus is less likely to produce bad odor due to absorption of the condensation water as compared to sponge, a thermal insulator, or the like. The blocking portion 310 is formed of a metal, more specifically, a stainless steel.

The blocking portion 310 includes a pressing portion 320 pressing on the resilient close-contact portion 390, a fixing portion 330 detachably fixed to the indoor heat exchanger 124, and a main body 340 connecting the pressing portion 320 and the fixing portion 330. The fixing portion 330 is detachably fixed to the upper surface 124b of the indoor heat exchanger 124 using a screw CL.

The main body 340 includes a first plate 350 that extends from the pressing portion 320 in a direction approaching the upper surface 124b and a second plate 360 that is bent at an end of the first plate 350 toward the fixing portion 330.

Each of the pressing portion 320, the fixing portion 330 and the main body 340 extends in the X-axis direction along the indoor heat exchanger 124. The pressing portion 320, the fixing portion 330 and the main body 340 are included in an integrated angle member obtained by bending stainless steel sheet metal in an L-shape.

The resilient close-contact portion 390 includes a close-contact portion 391 that is in close contact with the bottom surface 152a of the drain pan 152 and a fitting portion 392 that is formed integrally with the close-contact portion 391. The close-contact portion 391 forms a hollow tube extending in the X-axis direction. The fitting portion 392 fits together the pressing portion 320 and a part of the first plate 350 so as to be in close contact with the pressing portion 320 and the part of the first plate 350.

Furthermore, the railroad vehicle air conditioning apparatus 600 according to the present embodiment includes an upper-side blocking member 400, in order to suppress passage of the airflow AF between the indoor heat exchanger 124 and the top board 220. The upper-side blocking member 400 has configuration similar to that of the blocking member 300.

Specifically, the upper-side blocking member 400 includes an upper-side resilient close-contact portion 490 that is in resiliently close contact with the top board 220 and an upper-side blocking portion 410 that blocks a third gap GP3 between the upper-side resilient close-contact portion 490 and the indoor heat exchanger 124. The upper-side blocking portion 410 suppresses passage of the airflow AF through the third gap GP3.

The upper-side blocking portion 410 includes an upper-side pressing portion 420 pressing on the upper-side resilient close-contact portion 490, an upper-side fixing portion 430 detachably fixed to the indoor heat exchanger 124, and an upper-side main body 440 connecting the upper-side pressing portion 420 and the upper-side fixing portion 430. The upper-side fixing portion 430 is detachably fixed to the lower surface 124a of the indoor heat exchanger 124 using a screw CL.

The upper-side main body 440 includes an upper-side first plate 450 that extends from the upper-side pressing portion 420 in a direction approaching the lower surface 124a and an upper-side second plate 460 that is bent at an end of the upper-side first plate 450 toward the upper-side fixing portion 430.

The upper-side resilient close-contact portion 490 includes an upper-side close-contact portion 491 that is in close contact with the top board 220 and an upper-side fitting portion 492 that is formed integrally with the upper-side close-contact portion 491. The upper-side close-contact portion 491 forms a hollow tube extending in the X-axis direction. The upper-side fitting portion 492 fits together the upper-side pressing portion 420 and a part of the upper-side first plate 450 so as to be in close contact with the upper-side pressing portion 420 and the part of the upper-side first plate 450.

As described above, according to the present embodiment, since the blocking portion 310 blocks between the resilient close-contact portion 390 and the indoor heat exchanger 124, the blocking portion 310 suppresses passage of the airflow AF between the lower end portion 124e of the indoor heat exchanger 124 and the bottom surface 152a of the drain pan 152. This configuration suppresses a decrease in efficiency of heat exchange by the indoor heat exchanger 124, and additionally, suppresses scattering of the condensation water accumulated at the lower end portion 124e of the indoor heat exchanger 124 toward the outlet ports 250.

Furthermore, the blocking member 300 is arranged on a negative Y-axis direction side with respect to the water shutoff wall 152b and the water return portion 152c. That is, the blocking member 300 is arranged separately from the water shutoff wall 152b and the water return portion 152c. Due to this, the condensation water is prevented from travelling from the blocking member 300 to the water shutoff wall 152b and the water return portion 152c, resulting in a larger reduction in a possibility that the condensation water flows out to a position that is closer to the outlet ports 250 than the water shutoff wall 152b.

Furthermore, the blocking member 300 is fixed to the indoor heat exchanger 124 using the screw CL and thus is attachable to and detachable from the heat exchanger 124. This applies similarly to the upper-side blocking member 400. Due to this configuration, the blocking member 300 and the upper-side blocking member 400 is detachable from the indoor heat exchanger 124 for maintenance. Therefore, not only maintenance of the blocking member 300 and the upper-side blocking member 400 but also maintenance of the indoor heat exchanger 124, the drain pan 152, and the like, can be easily performed.

Furthermore, the upper-side blocking member 400 has configuration similar to that of the blocking member 300. That is, the upper-side blocking member 400 and the blocking member 300 can share component parts. This enables a lower number of components and an easier management of components than in the case in which the upper-side blocking member 400 has configuration different from that of the blocking member 300.

### Embodiment 2

As illustrated in FIG. 2, the first plate 350 faces the lower end surface 124c of the indoor heat exchanger 124 with a second gap GP2 left between the first plate 350 and the lower end surface 124c. An interposition portion for facilitating flow of condensation water down to the drain pan 152 may be disposed at the second gap GP2. Hereinafter, a specific example of such configuration is described.

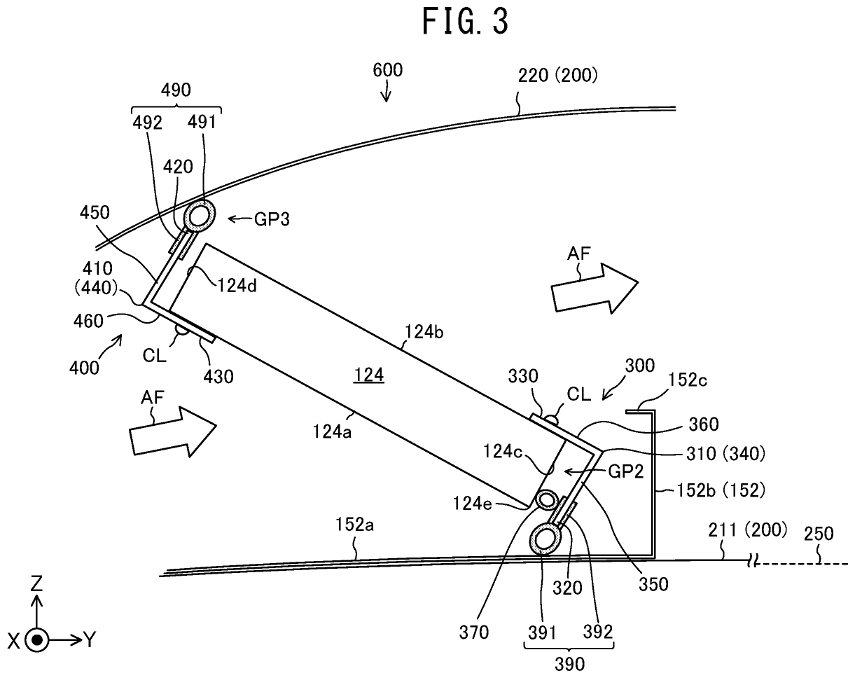

As illustrated in FIG. 3, the blocking member 300 according to the present embodiment further includes a hollow portion 370 as the interposition portion arranged at the second gap GP2. The hollow portion 370 forms a hollow tube extending in the X-axis direction along the lower end surface 124c.

The hollow portion 370 protrudes from the fitting portion 392 of the resilient close-contact portion 390 toward the lower end surface 124c of the indoor heat exchanger 124. The hollow portion 370 contacts the lower end surface 124c and thus serves for guiding the condensation water on the lower end surface 124c to the bottom surface 152a of the drain pan 152 through the resilient close-contact portion 390.

That is, the condensation water on the lower end surface 124c travels on the hollow portion 370 and the resilient close-contact portion 390 and flows down to the bottom surface 152a of the drain pan 152. Due to such operation, according to the present embodiment, the condensation water is less likely to settle on the indoor heat exchanger 124, in particular, at the lower end surface 124c and the lower end portion 124e. Thus, mold is less likely to be generated in the indoor heat exchanger 124, and additionally, discharge of the condensation water is performed smoothly.

The hollow portion 370 is formed integrally with the resilient close-contact portion 390 and has resilience. The hollow portion 370 is interposed, in a pressurized and compressed state, between the lower end surface 124c and the fitting portion 392. Due to such configuration, positional shift of the hollow portion 370 is less likely to occur even in the case of occurrence of shaking due to travelling of the railroad vehicle. Other configuration and effects are similar to those of Embodiment 1.

### Embodiment 3

The interposition portion arranged at the second gap GP2 is not limited to the hollow portion 370. Hereinafter, another example of the interposition portion is described.

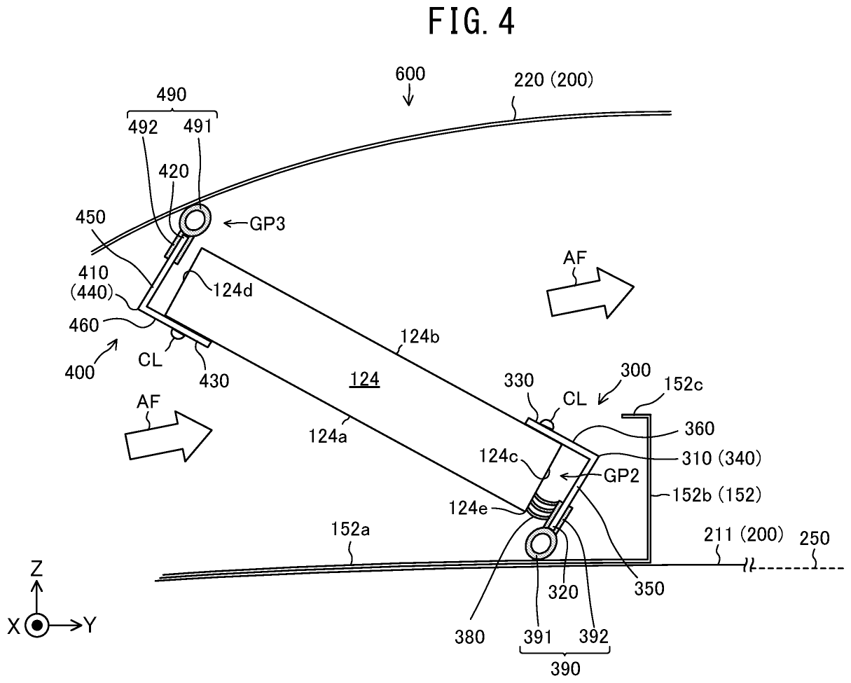

As illustrated in FIG. 4, the blocking member 300 according to the present embodiment includes multiple return portions 380 as the interposition portion arranged at the second gap GP2. The multiple return portions 380 (more specifically, three return portions 380) that each extend in the X-axis direction are aligned in the thickness direction of the indoor heat exchanger 124.

Each of the return portions 380 is formed integrally with the resilient close-contact portion 390 and has resilience. Each of the return portions 380 extends from the fitting portion 392 of the resilient close-contact portion 390 toward the lower end surface 124c of the indoor heat exchanger 124 and contacts the lower end surface 124c while resiliently pressing on the lower end surface 124c.

Similarly to the hollow portion 370 illustrated in FIG. 3, each of the return portions 380 serves for guiding the condensation water on the lower end surface 124c to the bottom surface 152a of the drain pan 152 through the resilient close-contact portion 390. That is, the condensation water on the lower end surface 124c travels on the return portions 380 and the resilient close-contact portion 390 and flows down to the bottom surface 152a of the drain pan 152. Thus, effects similar to those of Embodiment 2 are attainable.

### Embodiment 4

An element that functions similarly to the blocking member 300 according to Embodiments 1-3 described above can also be achieved an integrated synthetic resin molded body. Hereinafter, a specific example is described.

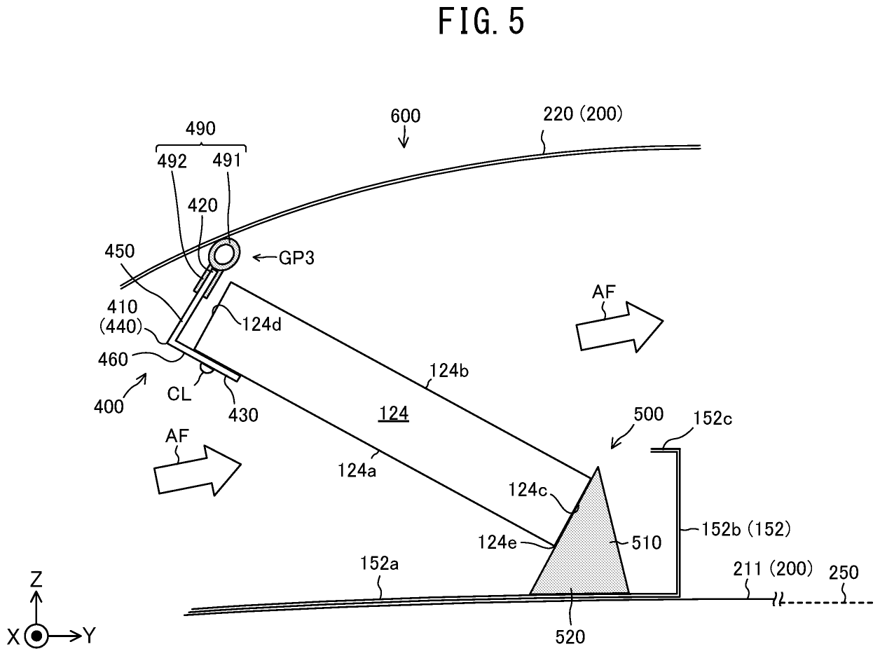

As illustrated in FIG. 5, a blocking member 500 according to the present embodiment is similar to the blocking member 300 according to Embodiments 1-3 described above in that there are included: (i) a resilient close-contact portion 520 that is in resiliently close contact with the bottom surface 152a of the drain pan 152 and (ii) a blocking portion 510 that blocks between the resilient close-contact portion 520 and the indoor heat exchanger 124, in a manner so as to transmit to the resilient close-contact portion 520 a part of the load of the indoor heat exchanger 124.

On the other hand, the blocking member 500 according to the present embodiment is included in a member that is formed integrally by synthetic resin, more specifically, polyurethane, as the resilient close-contact portion 520 and the blocking portion 510. That is, the whole blocking member 500 has resilience.

The blocking member 500 has a first side surface that is in resiliently close contact with the bottom surface 152a of the drain pan 152, a second side surface that is in resiliently close contact with the lower end surface 124c of the indoor heat exchanger 124, and a third side surface connecting the first side surface and the second side surface, and is formed in a form of a triangular pole having a height in the X-axis direction. The resilient close-contact portion 520 has the first side surface, and the blocking portion 510 has the second side surface and the third side surface.

Similarly to the aforementioned embodiments, since the blocking portion 510 blocks between the resilient close-contact portion 520 and the indoor heat exchanger 124, the blocking portion 510 suppresses passage of the airflow AF between the lower end portion 124e of the indoor heat exchanger 124 and the bottom surface 152a of the drain pan 152.

Embodiments 1-4 are described above. Embodiments 1-4 each describe example configuration for transmitting, by the blocking portion 310 or the blocking portion 510, a part of the load of the indoor heat exchanger 124 to the resilient close-contact portion 390 or the resilient close-contact portion 520. Configuration may be employed in which the blocking portion 310 or the blocking portion 510 transmits the entire load of the indoor heat exchanger 124 to the resilient close-contact portion 390 or the resilient close-contact portion 520. Various modifications and substitutions other than above can be made to Embodiments 1-4 without departing from the scope of the claims.

Hereinafter, various aspects of the present disclosure are supplementarily described.

Supplementary Note 1

A railroad vehicle air conditioning apparatus comprising:
a housing disposed in a railroad vehicle and having a return port and an outlet port that each open to a vehicular compartment of the railroad vehicle;
an indoor fan housed in the housing and configured to form, within the housing, a flow of air directed toward the outlet port from the return port;
an indoor heat exchanger arranged within the housing at a position through which the flow of the air passes and configured to perform heat exchange between the air and a refrigerant; and
a drain pan arranged within the housing below the indoor heat exchanger and configured to receive condensation water condensed at the indoor heat exchanger,
a lower end portion of the indoor heat exchanger being positioned, separately from a bottom surface of the drain pan, above the bottom surface, wherein
the railroad vehicle air conditioning apparatus further includes a blocking member that is detachable from the indoor heat exchanger, the blocking member including
   a resilient close-contact portion that is in resiliently close contact with the bottom surface of the drain pan, and
   a blocking portion that blocks between the resilient close-contact portion and the indoor heat exchanger in a manner so as to transmit to the resilient close-contact portion at least a part of load of the indoor heat exchanger.

Supplementary Note 2

The railroad vehicle air conditioning apparatus according to Supplementary Note 1, wherein the outlet port is disposed at a position of equal height to a position of the bottom surface of the drain pan or at a position of lower height than the position of the bottom surface of the drain pan.

Supplementary Note 3

The railroad vehicle air conditioning apparatus according to Supplementary Note 1 or 2, wherein the blocking portion includes
a pressing portion pressing on the resilient close-contact portion,
a fixing portion detachably fixed to the indoor heat exchanger, and
a main body connecting the pressing portion and the fixing portion.

Supplementary Note 4

The railroad vehicle air conditioning apparatus according to Supplementary Note 3, wherein
the indoor heat exchanger
   has a lower surface facing the bottom surface of the drain pan and an upper surface that is opposite to the lower surface with respect to a thickness direction of the indoor heat exchanger, and
   is arranged with inclination so as to approach the bottom surface of the drain pan with approach to the outlet port,
the fixing portion is detachably fixed to the upper surface, and
the main body includes
   a first plate that extends from the pressing portion in a direction approaching the upper surface, and
   a second plate that is bent at an end of the first plate toward the fixing portion.

Supplementary Note 5

The railroad vehicle air conditioning apparatus according to Supplementary Note 4, wherein
the first plate faces a lower end surface of the indoor heat exchanger that connects the upper surface and the lower surface, with a gap left between the first plate and the lower end surface, and
the blocking member further includes an interposition portion arranged at the gap so as to contact the lower end surface and configured to guide the condensation water on the lower end surface to the bottom surface of the drain pan through the resilient close-contact portion.

Supplementary Note 6

The railroad vehicle air conditioning apparatus according to any one of Supplementary Notes 3 to 5, wherein the resilient close-contact portion includes
a close-contact portion that is in close contact with the bottom surface of the drain pan, and
a fitting portion that is formed integrally with the close-contact portion and is fitted to the pressing portion.

Supplementary Note 7

The railroad vehicle air conditioning apparatus according to any one of Supplementary Notes 3 to 6, wherein
the drain pan includes a water shutoff wall extending upward from the bottom surface at a position between the indoor heat exchanger and the indoor fan, and
the blocking member is arranged separately from the water shutoff wall.

Supplementary Note 8

The railroad vehicle air conditioning apparatus according to Supplementary Note 1 or 2, wherein the blocking member is included in a member that is formed integrally by synthetic resin as the resilient close-contact portion and the blocking portion.

Supplementary Note 9

The railroad vehicle air conditioning apparatus according to Supplementary Note 8, wherein
the drain pan includes a water shutoff wall extending upward from the bottom surface at a position between the indoor heat exchanger and the indoor fan, and
the blocking member is arranged separately from the water shutoff wall.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A railroad vehicle air conditioning apparatus comprising:
a housing disposed in a railroad vehicle and having a return port and an outlet port that each open to a vehicular compartment of the railroad vehicle;
an indoor fan housed in the housing and configured to form, within the housing, a flow of air directed toward the outlet port from the return port;
an indoor heat exchanger arranged within the housing at a position through which the flow of the air passes and configured to perform heat exchange between the air and a refrigerant; and
a drain pan arranged within the housing below the indoor heat exchanger and configured to receive condensation water condensed at the indoor heat exchanger,
a lower end portion of the indoor heat exchanger being positioned, separately from a bottom surface of the drain pan, above the bottom surface, wherein
the railroad vehicle air conditioning apparatus further includes a blocking member that is detachable from the indoor heat exchanger, the blocking member including
a resilient close-contact portion that is in resiliently close contact with the bottom surface of the drain pan, and
a blocking portion that blocks between the resilient close-contact portion and the indoor heat exchanger in a manner so as to transmit to the resilient close-contact portion at least a part of load of the indoor heat exchanger.

2. The railroad vehicle air conditioning apparatus according to claim 1, wherein the outlet port is disposed at a position of equal height to a position of the bottom surface of the drain pan or at a position of lower height than the position of the bottom surface of the drain pan.

3. The railroad vehicle air conditioning apparatus according to claim 2, wherein the blocking portion includes
a pressing portion pressing on the resilient close-contact portion,
a fixing portion detachably fixed to the indoor heat exchanger, and
a main body connecting the pressing portion and the fixing portion.

4. The railroad vehicle air conditioning apparatus according to claim 3, wherein
the indoor heat exchanger
has a lower surface facing the bottom surface of the drain pan and an upper surface that is opposite to the lower surface with respect to a thickness direction of the indoor heat exchanger, and
is arranged with inclination so as to approach the bottom surface of the drain pan with approach to the outlet port,
the fixing portion is detachably fixed to the upper surface, and
the main body includes
a first plate that extends from the pressing portion in a direction approaching the upper surface, and
a second plate that is bent at an end of the first plate toward the fixing portion.

5. The railroad vehicle air conditioning apparatus according to claim 4, wherein
the first plate faces a lower end surface of the indoor heat exchanger that connects the upper surface and the lower surface, with a gap left between the first plate and the lower end surface, and
the blocking member further includes an interposition portion arranged at the gap so as to contact the lower end surface and configured to guide the condensation water on the lower end surface to the bottom surface of the drain pan through the resilient close-contact portion.

6. The railroad vehicle air conditioning apparatus according to claim 3, wherein the resilient close-contact portion includes
a close-contact portion that is in close contact with the bottom surface of the drain pan, and
a fitting portion that is formed integrally with the close-contact portion and is fitted to the pressing portion.

7. The railroad vehicle air conditioning apparatus according to claim 3, wherein
the drain pan includes a water shutoff wall extending upward from the bottom surface at a position between the indoor heat exchanger and the indoor fan, and
the blocking member is arranged separately from the water shutoff wall.

8. The railroad vehicle air conditioning apparatus according to claim 1, wherein the blocking portion includes
a pressing portion pressing on the resilient close-contact portion,
a fixing portion detachably fixed to the indoor heat exchanger, and
a main body connecting the pressing portion and the fixing portion.

9. The railroad vehicle air conditioning apparatus according to claim 8, wherein
the indoor heat exchanger
has a lower surface facing the bottom surface of the drain pan and an upper surface that is opposite to the lower surface with respect to a thickness direction of the indoor heat exchanger, and
is arranged with inclination so as to approach the bottom surface of the drain pan with approach to the outlet port,
the fixing portion is detachably fixed to the upper surface, and
the main body includes
a first plate that extends from the pressing portion in a direction approaching the upper surface, and
a second plate that is bent at an end of the first plate toward the fixing portion.

10. The railroad vehicle air conditioning apparatus according to claim 9, wherein
the first plate faces a lower end surface of the indoor heat exchanger that connects the upper surface and the lower surface, with a gap left between the first plate and the lower end surface, and
the blocking member further includes an interposition portion arranged at the gap so as to contact the lower end surface and configured to guide the condensation water on the lower end surface to the bottom surface of the drain pan through the resilient close-contact portion.

11. The railroad vehicle air conditioning apparatus according to claim 8, wherein the resilient close-contact portion includes
a close-contact portion that is in close contact with the bottom surface of the drain pan, and
a fitting portion that is formed integrally with the close-contact portion and is fitted to the pressing portion.

12. The railroad vehicle air conditioning apparatus according to claim 8, wherein
the drain pan includes a water shutoff wall extending upward from the bottom surface at a position between the indoor heat exchanger and the indoor fan, and
the blocking member is arranged separately from the water shutoff wall.

13. The railroad vehicle air conditioning apparatus according to claim 1, wherein the blocking member is included in a member that is formed integrally by synthetic resin as the resilient close-contact portion and the blocking portion.

14. The railroad vehicle air conditioning apparatus according to claim 2, wherein the blocking member is included in a member that is formed integrally by synthetic resin as the resilient close-contact portion and the blocking portion.

15. The railroad vehicle air conditioning apparatus according to claim 13, wherein
the drain pan includes a water shutoff wall extending upward from the bottom surface at a position between the indoor heat exchanger and the indoor fan, and
the blocking member is arranged separately from the water shutoff wall.

16. The railroad vehicle air conditioning apparatus according to claim 14, wherein
the drain pan includes a water shutoff wall extending upward from the bottom surface at a position between the indoor heat exchanger and the indoor fan, and
the blocking member is arranged separately from the water shutoff wall.
